(19) United States
(12) Patent Application Publication
(10) Pub. No.: US 2025/0280773 A1
(43) Pub. Date: Sep. 11, 2025

(54) METHOD AND EQUIPMENT FOR DISSOLVED OXYGEN ENRICHMENT OF IRRIGATION WATER FOR PLANT CULTIVATION

(71) Applicant: L'AIR LIQUIDE, SOCIETE ANONYME POUR L'EXPLOITATION DES PROCEDES GEORGES CLAUDE, PARIS (FR)

(72) Inventors: Franck COUSIN, Saint Brevin les Pins (FR); Pauline LE DRU, Beaucouzé (FR)

(21) Appl. No.: 18/855,808

(22) PCT Filed: Feb. 22, 2023
(86) PCT No.: PCT/EP2023/054385

§ 371 Date: Oct. 10, 2024

(30) Foreign Application Priority Data
Apr. 11, 2022 (FR) FR2203294

(51) Int. Cl. A01G 31/00; A01G 31/02; B01F 23/232; B01F 23/237; B01F 35/21; B01F 35/221; B01F 35/71; B01F 101/00

(52) U.S. Cl. CPC A01G 31/011; A01G 31/021; B01F 23/232; B01F 23/237612; B01F 35/2111; B01F 35/22162; B01F 35/712; B01F 35/718051; B01F 2101/305

(57) ABSTRACT

A method and equipment for plant cultivation, where the plants are supplied with water, over irrigation phases of specific duration spread over a 24 h day, which water has a given content of dissolved oxygen, characterized in that use is made of a system for boosting the injection of oxygen (or of an oxygen-containing gas mixture) in the irrigation water over a first period, of given duration, of one or some of the irrigation phases in question, and in that the remainder of the time of said irrigation phase(s) in question is characterized by a content of dissolved oxygen in the water which is nominal, i.e. lower than the boosted content of the first period.

### CROSS REFERENCE TO RELATED APPLICATIONS

This application is a 371 of International Application No. PCT/EP2023/054385, filed Feb. 22, 2023, which claims priority to French Patent Application No. 2203294, filed Apr. 11, 2022, the entire contents of which are incorporated herein by reference.

### FIELD OF THE INVENTION

The present invention relates to the cultivation of plants and in particular to the soilless cultivation of plants in a greenhouse. However, the technical solution proposed in the context of the present invention applies more generally to any method of cultivation of plants, and in particular cultivation in a controlled environment: in a greenhouse, in a cellar, sheltered from light, using a soilless, notably using a hydroponic, aquaponic, aeroponic, bioponic or other soilless methods.

### BACKGROUND

Thus, consider the case of production in a greenhouse, using soilless cultivation.

These productions are gaining ground all over the world, in rich and poor countries alike. They are one of the solutions for providing future generations with nutritious healthy food. To do this, they use scarce natural resources such as water and fertilizers in the most efficient way possible.

For example, it is generally considered that the cultivation of one kilo of tomatoes grown in the open field uses about 60 liters of water, while in soilless cultivation in a greenhouse, the water requirement is limited to about 15 liters.

In the case of a latest generation greenhouse, it is even possible to save an additional 4 liters per kilo. These savings are the result of more efficient use of water by controlling the oxygen content of the nutrient solutions.

Oxygen enrichment of irrigation water for soilless cultivation also makes it possible to increase the production yield:

The reasons why plant roots certainly need water but also need oxygen are well known, and especially the fact that when the oxygen content in the soil is not sufficient, the absorption of water by the plant is limited and the susceptibility of the plant to diseases is increased.

It is also known that oxygen enrichment of irrigation water using air limits the content to a maximum of 10 mg/L, whereas dissolved-oxygen enrichment using pure oxygen (O₂) makes it possible to reach much higher contents (typically 40 mg/L).

The systems used to carry out this enrichment are very varied; in particular porous materials, static mixers and other oxygenators which are commercially available, such as those proposed by FOX (“France Oxygenation”), are known.

Nevertheless, it is known that this equipment is in fact sold for applications in the field of water treatment, or else for fish farming. And so they are, in fact, designed to operate continuously.

However, in this field of soilless cultivation, irrigation is not carried out continuously; it responds to cycles corresponding to the needs of the plants, depending in particular on the temperature and light levels prevailing in the greenhouse. Watering is then done discontinuously to ensure that the roots return to the air, with injection and pause cycles etc.

In practice, it is observed that the procedures commonly followed include fairly short watering phases, of the order of 10 minutes, and while, at the beginning of the season, watering is carried out about 4 times a day, at the end of cultivation there may be as many as 24 watering operations per day.

In practice, it is therefore found that there are, in the field, difficulties in controlling the supply of oxygen to the plant. The experiments conducted by the applicant have made it possible to understand the origin of these difficulties and to make, within the scope of the present invention, proposals for overcoming these difficulties.

Indeed, when a producer site launches a watering phase, for a given period of time, for example 10 minutes, it also initiates the simultaneous injection of oxygen, for example pure oxygen (but this can also be a gas mixture containing oxygen, preferably a mixture comprising at least 25% oxygen), into the water reaching the plants, but the oxygenation equipment available on the market, as has been recalled above, all require a certain time to reach the set-point value for dissolved oxygen in the water concerned, for example, to reach 35 mg/L, and this “lag” time can be as much as 5 to 10 minutes, or even 15 minutes in some cases.

As can be seen, this technical feature therefore has a negative impact on the plants, since existing systems do not provide them with the oxygen content they require throughout a given irrigation phase.

### SUMMARY

It is therefore the merit of the present invention to have evaluated these difficulties and to propose here a technical solution that can be summarized as follows:
According to the present invention, it is proposed that the injection of oxygen be “boosted” during a first part, of a given duration, of an irrigation phase considered (of one of the phases or several of the phases of irrigating the crop considered, and preferably at least for an irrigation phase following an irrigation stoppage (a restart));
As an illustration for a better understanding the invention, over a given irrigation phase of 10 minutes, where the intention is to provide the plant with a (set-point) dissolved-oxygen content of 35 or 40 mg/liter, the injection of oxygen will be “boosted” during the first 30 seconds of the irrigation phase, i.e. a dissolved-oxygen content that is higher than the target setpoint will be employed;
In other words, for a given phase, oxygen is delivered to the irrigation water at two flow rates: a boost flow rate (or “increased” flow rate) during a given boost period (for example 30 seconds) and then, after this first period, an oxygen flow rate that can be qualified as “nominal”, i.e. set-point, will be adopted during the rest of the irrigation phase;
According to one advantageous way of implementing such a double flow rate, use is made of an installation comprising a flow sensor, situated on the water supply line arriving at the greenhouse (or more generally at the crop, whatever the cultivation method used), and two supply lines for admitting oxygen or a mixture containing oxygen into the water supply line, each oxygen supply line being equipped with a flowmeter in series with an electrically operated valve, one of the two electrically operated valves being on a timer. Thus, at the start of irrigation, the flow sensor detects the passage of water, and it orders the opening of the two electrically operated valves, only one of which is on a timer, timed for example, to a value of 30 seconds. Thus, the gas arrives via the two gas lines, then after 30 seconds the timed line stops (closes) and the gas then passes only via the second line for the rest of the irrigation phase concerned.
According to one of the embodiments of the invention, the duration of said period of time during which the oxygen content is boosted falls within a time-in-seconds range from 0.5 to 1.5 times the water flow rate in m³/h, thus by way of illustration, for a water flow rate of 38 m³/h, the boost time will fall in the range between 38×0.5=19 seconds and 38×1.5 =57 seconds.

### DETAILED DESCRIPTION OF PREFERRED EMBODIMENTS

As will become clear to those skilled in the art, the installation solution described above is extremely advantageous because it is very inexpensive.

Now, it might be possible, as a first approach, to consider another way of achieving this oxygen boost, using a mass flow controller (“MFC” in the field of industrial gases), coupled with a regulator, so that when the contactor detects the water flow rate, it orders, via the regulator, an oxygen flow rate that is, for example, twice as high as the demand for 30 seconds, the regulator then reducing the flow rate to settle on a nominal (not boosted) demand.

It will then be well understood that this latter potential embodiment, which is very reliable and highly luxurious, is also incredibly more expensive, so it is therefore not preferred according to the present invention.

The invention therefore relates to a method for cultivating plants, wherein the plants are supplied with water during irrigation phases of determined duration, spread over a 24-hour day, which water has a given dissolved-oxygen content, characterized in that:
a system is used to boost the injection of oxygen or of a gaseous mixture containing oxygen into the irrigation water during a first period, of given duration, of one or of some of the irrigation phases concerned, through the fact that the oxygen content in the water during said first period is greater than a given set-point; and in that
the remainder of the time of said irrigation phase(s) concerned, (the first period of which has been boosted), is characterized by a dissolved-oxygen content of the water which is equal to said set-point, i.e. which is thus lower than the boosted content of the first period.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A method for cultivating plants, wherein the plants are supplied with water during irrigation phases of determined duration, spread over a 24-hour day, which water has a given dissolved-oxygen content, comprising:
boosting the injection of oxygen or of a gaseous mixture containing oxygen into an irrigation water during a first period, of given duration, of one or of some of the irrigation phases concerned, through the fact that the oxygen content in the irrigation water during said first period is greater than a given set-point,
wherein
the remainder of the time of said irrigation phase(s) concerned, the first period of which has been boosted, is characterized by a dissolved-oxygen content of the irrigation water which is equal to said set-point.

2. The method of claim 1, wherein the duration of said first period of time during which the oxygen content is boosted falls within a time-in-seconds range from 0.5 to 1.5 times the flow rate of water in m³/h supplied to the crop during the phase under consideration.

3. The method of claim 1, wherein the system for boosting the injection of oxygen into the irrigation water comprises an installation comprising:
a flow rate sensor, located on the water inlet line, configured to supplying water to the crop, and
two supply lines, configured to admit to oxygen or a mixture containing oxygen into the water supply line, each supply line for oxygen or mixture being equipped with a flowmeter in series with an electrically operated valve, one of the two electrically operated valves being on a timer,
wherein at the start of an irrigation phase, a first period of which is boosted with oxygen, the flow rate sensor detects the passage of water, and orders the opening of the two electrically operated valves, only one being on a timer timed for said first period of given duration, and thus allows the gas to arrive via the two gas lines and then, when said first period of given duration expires causes the timed line to close, so that the gas then passes only through the second line alone for the rest of the irrigation phase concerned.

4. The method of claim 1, wherein said plant cultivation is cultivation in a controlled medium, using one of the following methods: in a greenhouse, in a cellar protected from light, using a soilless, hydroponic, aquaponic, aeroponic, or bioponic-or other method.

5. The method of claim 1, wherein the oxygen injection is boosted during a first part, of given duration, of at least one or some of the irrigation phases following an irrigation stoppage.

6. The method of claim 1, wherein the oxygen injection is boosted during a first part, of given duration, of all the irrigation phases spread over 24 hours.

7. A plant cultivation equipment, wherein the plants are supplied with water during irrigation phases of determined duration, spread over a 24-hour day, which water contains a given dissolved-oxygen content, the plant cultivation equipment comprising:
at least one irrigation water supply line, configured to supplying water to the crop;
means of injecting oxygen or a gas containing oxygen into the irrigation water; wherein the installation comprises a flow rate sensor, located on the water supply line supplying water to the crop, and in that the means for injecting oxygen or a mixture containing oxygen comprise two supply lines for admitting oxygen or a mixture containing oxygen into the water supply line, each gas supply line being equipped with a flowmeter in series with an electrically operated valve, one of the two electrically operated valves being on a timer.

8. The plant cultivation equipment of claim 7, wherein said plant cultivation is cultivation in a controlled medium, using one of the following methods: in a greenhouse, in a cellar protected from light, using a soilless, hydroponic, aquaponic, aeroponic, or bioponic.

9. The method of claim 1, wherein the remainder of the time of said irrigation phase(s) concerned, the first period of which has been boosted, is characterized by a dissolved oxygen content of the irrigation water which is thus lower than the boosted content of the first period.
